(19) United States
(12) Patent Application Publication
(10) Pub. No.: US 2026/0299666 A1
(43) Pub. Date: Oct. 1, 2026

(54) PERFORMANCE STATE AWARE DYNAMIC CLOCK GATING

(71) Applicant: Apple Inc., Cupertino, CA (US)

(72) Inventors: Chandan SHANTHARAJ, San Jose, CA (US); FNU Rajeev KUMAR, Santa Clara, CA (US); Sahil KAPOOR, Saratoga, CA (US); Shashank SHASTRY, Saratoga, CA (US); Venkata Srikanth PALANKI, Santa Clara, CA (US)

(21) Appl. No.: 19/089,363

(22) Filed: Mar. 25, 2025

(51) Int. Cl. G06F 1/324; G06F 1/3228

(52) U.S. Cl. CPC G06F 1/324; G06F 1/3228

(57) ABSTRACT

A processor circuit having performance state-aware clock-gating is disclosed. A processor circuit includes a plurality of circuit blocks and a power management circuit. The power management circuit determines a workload demand for the circuit blocks. In response to a determination that the workload demand is less than a threshold level, the power management circuit changes a performance state from a first performance state to a second performance state that consumes less power. The power management circuit further, in the second performance states, activates a first operational mode (e.g., that performs clock-gating of various circuits) based on a timing margin associated with the second performance state.

### FIELD

The described embodiments relate generally to integrated circuits, and more particularly, to mechanisms for saving power in integrated circuits.

### BACKGROUND

Modern processor circuits operate in various performance states. A given performance state may be based on a clock frequency. Higher performance states correspond to higher clock frequencies. At the higher clock frequencies, a processor may conduct more operations in a given amount of time. However, this may come at the expense of more power, as a processor circuit operating at a higher clock frequency consumes more dynamic power. When performance demands are reduced, a processor circuit may operate at a lower performance state having a lower clock frequency, thereby consuming less dynamic power. This may help increase the amount of performance by the processor circuit per watt of power consumed.

Further optimizations to increase the performance-per-watt may also be implemented in various processor circuits. For example, idle circuits may be clock-gated and/or power-gated. When a given circuit is clock-gated, a clock signal is inhibited from being provided thereto, thereby preventing unnecessary toggling of sequential circuits. Power-gating may inhibit power from being provided to idle circuits, which may prevent consumption of both static and dynamic power.

### BRIEF DESCRIPTION OF THE DRAWINGS

FIG. 1 is a block diagram depicting an embodiment of a processor circuit and a power management circuit.

FIG. 2 is a block diagram of one embodiment a circuit block in a processor circuit.

FIG. 3A is a logic diagram illustrating an example of exclusive-OR clock-gating carried out in one embodiment of a processor circuit.

FIG. 3B is a logic diagram illustrating one embodiment of a flip-flop circuit configurable for power savings in a reduced power performance state.

FIG. 4 is a flow diagram of one embodiment of a method for operating a processor circuit.

FIG. 5 is a flow diagram of another embodiment of a method for operating a processor circuit.

FIG. 6 is a block diagram of an embodiment of a device that includes performance state-aware clock-gating.

FIG. 7 is a block diagram of various embodiments of computer systems that may include performance state-aware clock-gating.

FIG. 8 illustrates an example of a non-transitory computer-readable storage medium that stores circuit design information.

### DETAILED DESCRIPTION

Certain types of integrated circuits, such as high-performance processor circuits, operate at very high clock frequencies and may have multiple levels of architectural clock-gating circuits to reduce unnecessary clock toggles (by inhibiting the clock signal from being provided to clocked circuits) to save dynamic power. While the peak performance of the processing circuits may provide processing power for high performance or a good user experience, such processors may be limited by thermal design power and may thus switch to lower performance states to provide sustained performance. As defined herein, a performance state includes a unique combination of operating voltage and clock frequency relative to other performance states. Higher performance states (for better processing performance and heavy workloads) may involve higher operating voltages and higher frequencies. Lower performance states (for more efficient power consumption) may involve lower operating voltages and lower clock frequencies, thereby consuming less power at the expense of the performance attainable in the higher performance states.

While clock-gating may be used to save dynamic power in various ones of the different performance states, it may be limited in higher performance states. Various types of sequential circuits have a setup time for clocked circuits therein. Setup time is defined as the amount of time an input should be stable prior to a clock edge. At higher clock frequencies, there may be less slack in the setup and hold times for carrying out clock-gating. Accordingly, clock-gating at higher frequencies may not always be practical or achieve the desired results.

The present disclosure makes use of the insight that, a lower clock frequencies and lower voltage performance states, the available timing margins for performing clock-gating is greater than at higher clock frequencies, increasing as the clock frequency falls. Accordingly, the present disclosure is directed to various mechanisms for performing additional clock-gating at lower frequencies to achieve additional dynamic power savings. By performing the additional clock-gating at lower performance states (with lower clock frequencies), additional power may be saved above and beyond the expected power savings. This may provide further optimization of the power-per-performance envelope for the processor circuit and may also result in reduced thermal output. As a result, a processor circuit utilizing the various clock-gating mechanisms disclosed herein may more easily operate within specified power/performance envelopes.

As used herein the term “processor circuit” is defined as any type of circuit that processes data and includes circuits that operate using a clock signal. Accordingly, the disclosure contemplates the various clock-gating mechanisms being carried out in general-purpose processors, graphics processor, digital signal processors, FPGA circuits, application-specific integrated circuits (ASICs), and so on.

The discussion below begins with an example of a processing circuit with a power management circuit and an example circuit block with clock-gating capability. Thereafter, an example of one type of clock-gating is discussed, as is an example of a flip-flop circuit which may enable additional power savings at lower performance states. Methods of operating a clock circuit are then discussed, and the disclosure concludes with descriptions of an example device and system which may implement the clock-gating mechanisms of the disclosure, along with a computer-readable medium that may store design information.

### Processor Circuit and Circuit Blocks

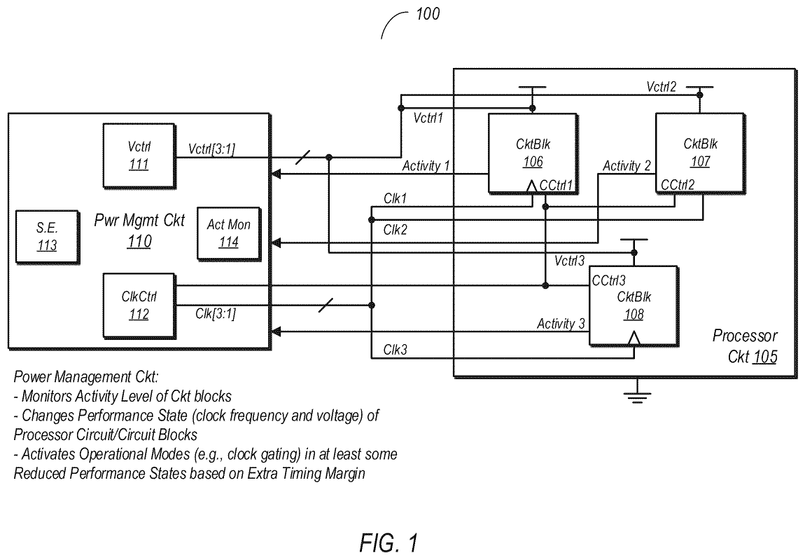

FIG. 1 is a block diagram depicting an embodiment of a system having a processor circuit and a power management circuit. Processor circuit 105 and power management circuit 110 of system 100 in the embodiment shown may be implemented on a single integrated circuit die, as separate integrated circuits within a single package, as separate integrated circuits in separate packages mounted on a printed circuit board (PCB), or any other suitable arrangement.

In the embodiment shown, processor circuit 106 includes circuit block 106, circuit block 107, and circuit block 108, each of which includes functional circuitry therein to carry out the processor's intended functions. Other functional circuit blocks may also be present, as those shown here are by way of example. The functions carried out by the various circuit blocks 106, 107, and 108 may vary depending on the intended use of processor circuit 105. In various embodiments, processor circuit 105 may be a general-purpose processor (e.g., central processing unit, or CPU) for one of a number of different types of computing devices, a graphics processor, a digital signal processor, an ASIC, or any other type. Generally speaking, processor 105 may be any type of integrated circuit (or portion thereof) in which data is processed using clocked circuits. The functional circuit blocks 106, 107, and 108 may be, for example, various types of processor cores, memory controllers, graphics processing circuitry, interface circuitry (internal and/or external) and so on.

Power management circuit 110 in the embodiment shown carries out various functions to optimize the performance delivered per the amount of power consumed by processor circuit 105. As will be explained in further detail below, power management circuit 110 in the embodiment shown is capable of carrying out performance state-aware clock-gating to provide further power savings and power-per-performance optimization.

In carrying out its intended functions, power management circuit 110 may control the power supply voltages delivered to the various circuit blocks 106, 107, and 108 of processor circuit 105, and may further control the frequency of clock signals delivered thereto. To this end, power management circuit 110 may control a performance state of processor circuit 105 and the various circuit blocks thereof. A given performance state includes a combination of a supply voltage and a clock frequency that is unique with respect to the other performance states. For higher performance demands and heavier workloads, power management circuit 110 may cause processor circuit 105 or a circuit block thereof to operate in a performance state with a higher voltage and higher clock frequency (relative to at least some of the other available performance states). For lighter workloads, power management circuit 110 may cause processor circuit 105 or the circuit blocks 106, 107, and 108 thereof to operate in a performance state with a lower voltage and lower clock frequency.

In the embodiment shown, power management circuit 110 may control the performance states of the circuit blocks 106, 107, and 108 at least partially independent of one another. Independent control may be limited in some embodiments by, e.g., thermal output specifications for the entirety of processor circuit 105. In other embodiments, power management circuit 110 may control the performance state of processor 105 as a single entity such that each of circuit blocks 106, 107, and 108 is operating in the same performance state at a given time.

Control of the performance state for circuit blocks 106, 107, and 108 may be carried out using voltage control circuit 111 and clock control circuit 112. Voltage control circuit 111 in the embodiment shown may control the supply voltage sent to each of the various circuit blocks 106, 107, and 108 of processor circuit 105. In some embodiment, voltage control circuit 111 may include one or more power supply circuits (e.g., DC-DC converters, such as buck converters) in which their respective output voltages are adjustable (e.g., through adding or shedding phases in a multi-phase buck converter). In other embodiments, the respective power supplies may be off-chip in another part of system 100, while voltage control circuit 111 generates control signals (e.g., Vctrl1, Vctrl2, and Vctrol3) to control the supply voltage levels.

Clock control circuit 112 in the embodiment shown is configured to both generate clock signals (Clk1, Clk2, and Clk3 in this example) as well as clock control signals (CCtrl1, CCtrl2, CCtrl3, received by respective ones of circuit blocks 106, 107, and 108). These control signals may be used for various functions, including clock-gating, and may also be used to control the frequency of clock signals provided to their respective one of circuit blocks 106, 107, and 108 (e.g., by controlling a clock divider circuit). It is noted that embodiments in which the clock signals are generated elsewhere, including in circuitry within processor circuit 105 itself, are possible and contemplated.

To determine an appropriate performance state for the various ones of circuit blocks 106, 107, and 108, power management circuit 110 includes an activity monitoring circuit 114, which receives respective activity signals (Activity 1, Activity 2 and Activity 3). These signals may indicate the respective activity levels and/or anticipated workloads of their corresponding one of circuit blocks 106, 107, and 108. Since circuit blocks 106, 107, and 108 may carry out different functions with respect to one another, the activity signals may vary in the information conveyed thereby. For example, for a compute complex including one or more execution units, the activity signals could carry information indicating the number of instructions that have been scheduled or are pending scheduling for execution. In another example, for a memory controller, the activity signals may indicate a number of pending memory transactions along with any quality-of-service (QoS) information.

Using the received activity signals for the various ones of circuit blocks 106, 107, and 108 as received by activity monitoring circuit 114 may determine respective performance states to balance power consumption and performance. Upon making this determination, voltage control circuit 111 and clock control circuit 112 may carry out adjustments to respective control signals to cause corresponding ones of circuit blocks 106, 107, and 108 to enter their indicated performance states.

As noted above, certain operational modes such as enhanced clock-gating may be activated by power management circuit 110 in certain lower performance states. In lower performance states, with lower clock frequencies, timing margins may allow for more aggressive clock-gating, thereby achieving additional power savings. At higher clock-frequencies frequencies, clock-gating may not be practical in some situations, such as short idle times, due to setup times for various sequential circuits thereof. However, at lower clock frequencies, the additional timing margins may allow for clock-gating even for very small intervals (e.g., a few clock cycles) when circuits are temporarily idle.

When the more aggressive clock-gating is applied over a large number of circuits, the power savings can be significant. In some instances, the power saved in a given performance state using enhanced clock-gating may be such that the power consumed by processor circuit 105 may correspond to that of an even lower power state. Accordingly, in the embodiment shown, power management circuit 110 includes a storage element 113 which stores information indicating which circuits are available for clock-gating in lower performance states. The information stored in storage element 113 may also indicate different types of clock-gating that may be carried out, and may further specify idle times for performing such clock-gating. Clock control circuit 112 may access storage element 113 in various ones of the performance states to determine which circuits are available for clock-gating and may generate clock control signals in accordance therewith. The control signals may then be provided to various clock-gating circuits within

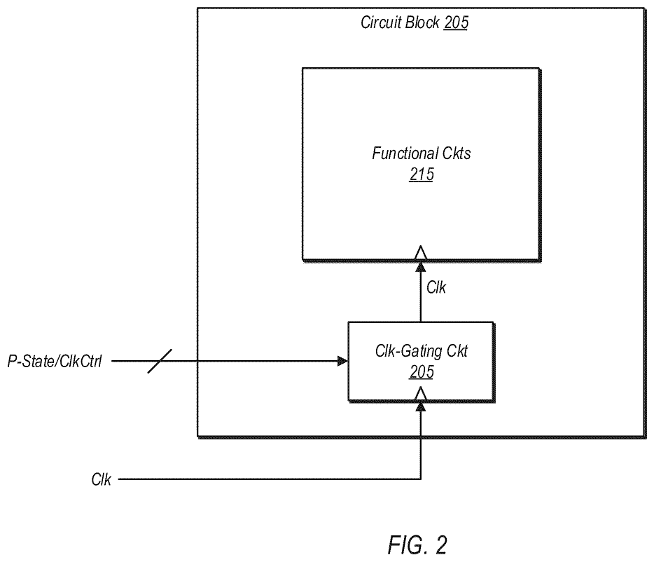

FIG. 2 is a block diagram of a circuit block that includes clock-gating functionality. Circuit block 205 may correspond to any one of circuit blocks 106, 107, and 108 of FIG. 1. In the embodiment shown, circuit block 205 includes a clock-gating circuit 205 and functional circuits 215. Functional circuits 215 includes various clocked circuits therein that operate in accordance with a clock signal, Clk. The clock signal as shown here is received from an external source, and may be allowed to pass or may be inhibited from passaged by clock-gating circuit 205.

Clock-gating circuit 205 may be implemented using various types of clock-gating circuits, such as an AND-based clock-gating circuit. Other clock-gating logic may also be included within clock-gating circuit 205. As shown here, clock-gating circuit 205 is coupled to receive performance state indications (P-State) and control signals (ClkCtrl) that can be used to determine when clock-gating can be carried out in circuit block 205. Using these signals, clock-gating of functional circuits 215 may be enabled or disabled. When transparent, the clock signal as received from an external source may pass through clock-gating circuit for distribution to functional circuits 215. When clock-gated, the clock signal is inhibited from being provided to functional circuits 215.

The transparency of clock-gating circuit 205 may be dependent on the performance state and respective states of the control signals. At lower performance states, clock-gating may be carried out for idle times of even a small number of clock cycles, a number which may change with changes in the performance state.

### Power Saving Circuit Examples

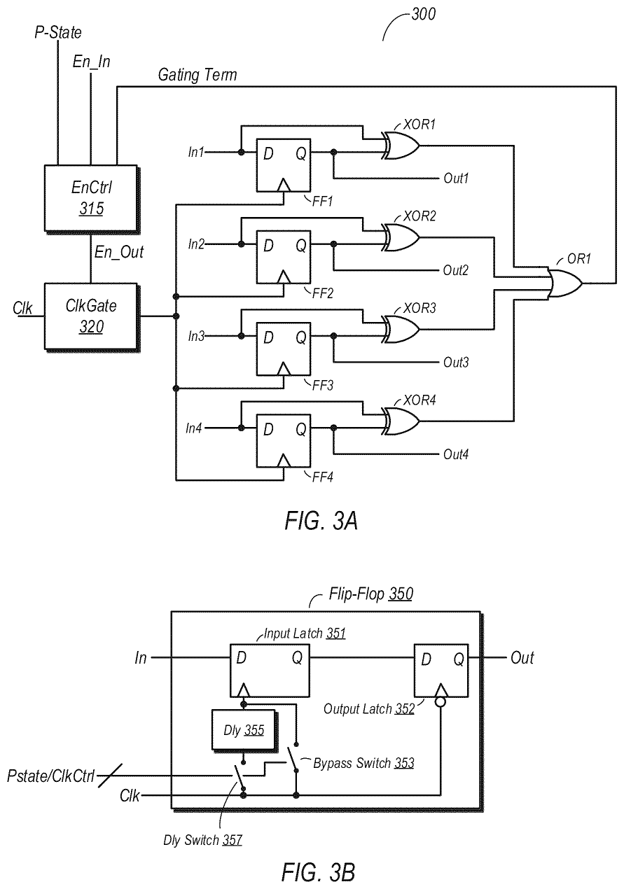

FIG. 3A is a logic diagram illustrating an example of exclusive-OR clock-gating carried out in one embodiment of a processor circuit. The exclusive-OR clock-gating carried out by circuit 300 may be implemented in various ones of the circuit blocks 106, 107, and 108 of processor circuit 105 of FIG. 1, and more generally in various circuits in which the clock-gating of the present disclosure may be carried out.

Circuit 300 in the embodiment shown includes four flip-flops, FF1-FF4, each of which is coupled to receive a corresponding one of input signals, In1-In4, and to generate a corresponding one of output signals, Out1-Out4. These inputs and outputs may be coupled to other circuits, which may be within the same circuit block or within another circuit block of the processor circuit in which circuit 300 is implemented.

Circuit 300 further includes exclusive-OR gates XOR1-XOR4, each of which is coupled to a corresponding one of flip-flops FF1-FF4. More particularly, each of exclusive-OR gates XOR1-XOR4 includes a first input coupled to an input of its corresponding flip-flop FF1-FF4, and a second input coupled to the output of its corresponding flip-flop. Accordingly, each of the exclusive-OR gates XOR1-XOR4 may effectively perform a comparison of the respective states of the input and output of its correspondingly coupled one of flip-flops FF1-FF4. If the input and output of a given one of flip-flops FF1-FF4 is different (indicative of activity), its correspondingly coupled one of XOR1-XOR4 generates a logic 1. If the respective states of the input and output of a given one of FF1-FF4 are the same (which may indicate a lack of activity), the corresponding one of XOR1-XOR4 generates a logic 0.

The respective outputs of the exclusive-OR gates XOR1-XOR4 are each provided as an input to an OR gate, OR1. The output of OR1 in this embodiments is a gating term. When the gating term is a logic 1, at least one of flip-flops FF1-FF4 is active. However, if none of flip-flops FF1-FF4 are active, the gating term may be a logic 0. In certain performance states, clock-gating of flip-flops FF1-FF4 may be carried out based on the state of the gating term.

In this embodiment, the gating term is received by enable control (EnCtrl) logic 315. A performance state (P-State) signal and an input enable signal (En_In) is also provided to enable control logic 315. The performance state and input enable signals may be provided from a power management circuit such at that discussed above with respect to FIG. 1. The input enable signal, En_In, may, when asserted, indicate to enable control logic 315 that the clock signal is to be passed to downstream circuits if no other conditions are present that would cause clock-gating to be carried out. If the input enable signal is de-asserted, clock-gating of circuit 300 may be carried out

Using the P-State signal, which indicates a current performance state in which circuit 300 is operating, enable control logic 315 may determine if circuit 300 may perform clock-gating based on the clock-gating term. In higher performance states, when timing margins are smaller, enable control logic 315 may prevent clock-gating from being carried out based on the state of the clock-gating term output by OR-gate OR1. However, in lower performance states, enable control logic 315 may permit clock-gating based on the state of the clock-gating term.

Enable control logic 315 is configured to generate an output enable signal, En_Out, which is provided to clock-gating circuit 320, which may be implemented using any suitable type of clock-gating circuitry, such as an AND-type clock gating circuit. When the output enable signal is asserted, the clock gating circuit is transparent to the clock signal, Clk, which is passed to the clock inputs of flip-flops FF1-FF4. When the output enable signal is de-asserted, the clock signal may be inhibited from flip-flops FF1-FF4, thereby preventing the toggling of the clock signal on their respective clock inputs and saving dynamic power. The output enable signal may be de-asserted whenever the input enable signal is de-asserted in this particular embodiment, irrespective of the gating term and performance state signals. In at least some low performance states (as indicated by the performance state signal), the output enable signal may be de-asserted when the gating term is also de-asserted, even if the input enable signal is otherwise asserted.

It is noted that the arrangement shown here may be implemented for any number of flip-flop circuits, with as few as one (which would allow elimination of the OR gate). The arrangement of circuit 300 may further allow for clock-gating for even very small numbers of clock cycles when the respective inputs and outputs of the relevant flip-flop circuits (or more generally sequential circuits) remain unchanged. The dynamic power savings from such clock-gating may allow for additional power savings above and beyond that which is achievable with more traditional clock-gating approaches. Furthermore, circuit arrangements based on the same principles of circuit 300 of FIG. 3A may allow for more localized clock-gating, further enhancing the dynamic power savings.

FIG. 3B is a logic diagram illustrating one embodiment of a flip-flop circuit configurable for power savings in a reduced power performance state. In the embodiment shown, flip-flop circuit 350 includes an input latch 351 and an output latch 352. The input signal may be latched into input latch 351 during a first phase of a clock signal, and received and latched by the output latch 352 during a second phase of the clock signal.

With respect to input latch 351, the clock signal may be received via a delay circuit 355 or through bypass switch 353. During operation in higher performance states (indicated by the performance state signal), delay circuit 355 may be active (as a result of closing delay switch 357) while bypass switch 353 is open. The delay provided by delay circuit 355 may aid in meeting timing specifications when operating at higher clock frequencies, but may also increase power consumption of flip-flop circuit 350, as well as power consumption due to the clock signal provided to flip-flop circuit. However, at lower clock frequencies, the timing specifications may be met without the added delay provided by delay circuit 355. According, at these lower clock frequencies, the performance state and control signals provided to flip-flop circuit 350 may be used to disable the delay circuit 355 by opening delay switch 357 while also closing the bypass switch 353 such that the clock signal is provided to input latch 351 in a more direct manner. This may save some dynamic power even when flip-flop circuit 350 is not otherwise clock-gated. However, using the control signals, clock-gating may be carried out to at least the input latch 351 of flip-flop circuit 350 at lower performance states by opening bypass switch 353. Furthermore, although not explicitly shown here, an additional switch may be present to inhibit (when opened) the clock signal from being provided to the output latch 352 when bypass switch 353 is also open. Control of clock-gating of flip-flop circuit 350 may be carried out in various forms, such as using the exclusive-OR-based clock-gating discussed above with reference to FIG. 3A.

### Methods of Operation

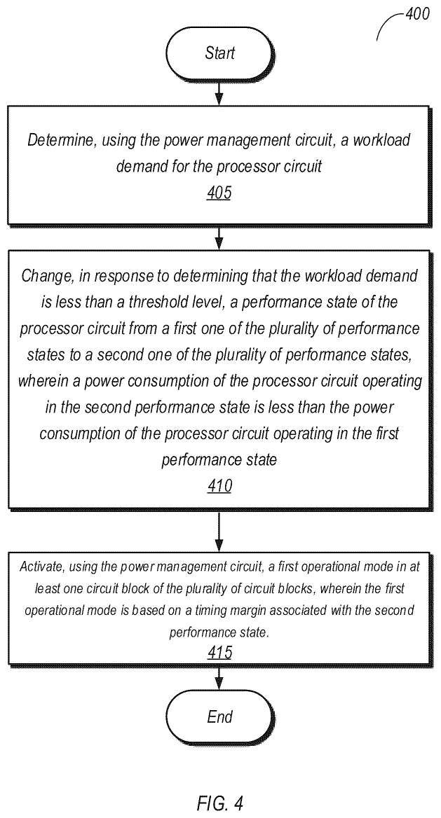

FIG. 4 is a flow diagram of one embodiment of a method for operating a processor circuit. Method 400 may be carried out by any embodiment of a processing circuit as discussed elsewhere herein. Furthermore, a processing circuit capable of carrying out Method 400, but not otherwise discussed herein, is considered to fall within the scope of this disclosure.

Method 400 includes determining, using a power management circuit, a workload demand for a processor circuit having a plurality of circuit blocks (block 405). The method further includes changing, in response to determining that the workload demand is less than a threshold level, a performance state of the processor circuit from a first one of a plurality of performance states to a second one of the plurality of performance states, wherein a power consumption of the processor circuit operating in the second one of the plurality of performance states is less than the power consumption of the processor circuit operating in the first one of the plurality of performance states (block 410). The method also includes activating, using the power management circuit, a first operational mode in at least one circuit block of the plurality of circuit blocks, wherein the first operational mode is based on a timing margin associated with the second one of the plurality of performance states (block 415).

In various embodiments of the method, activating the first operational mode comprises, based on the timing margin associated with the second one of the plurality of performance states, clock-gating of the at least one circuit block using one or more clock-gating circuits implemented within the at least one circuit block. Such embodiments may also include storing, in a table of the power management circuit, information indicative of which ones of the plurality of circuit blocks is available for clock-gating when operating in the second one of the plurality of performance states. These embodiments may also include monitoring, using one or more activity monitoring circuits implemented in the power management circuit, respective activity levels for one or more of the plurality of circuit blocks, and may further include activating, using the power management circuit, clock-gating based on an activity level detected by a particular one of the one or more activity monitoring circuits.

Some embodiments of the method include clock-gating a first sequential circuit in in the at least one circuit block by comparing, using an exclusive-OR gate, an input of the first sequential circuit to an output of the first sequential circuit. These embodiments may be extended to include clock-gating a plurality of sequential circuits, including the first sequential circuit by comparing, using corresponding ones of a plurality of exclusive-OR gates, respective inputs to respective outputs of ones of the plurality of sequential circuits and logically ORing respective outputs of the plurality of exclusive-OR gates to generate a clock-gating term.

In various embodiments, operating in the first one of the plurality of performance states comprises operating the processor circuit at a first clock frequency and operating the second one of the plurality of performance states comprises operating the processor circuit at a second clock frequency that is less than the first clock frequency.

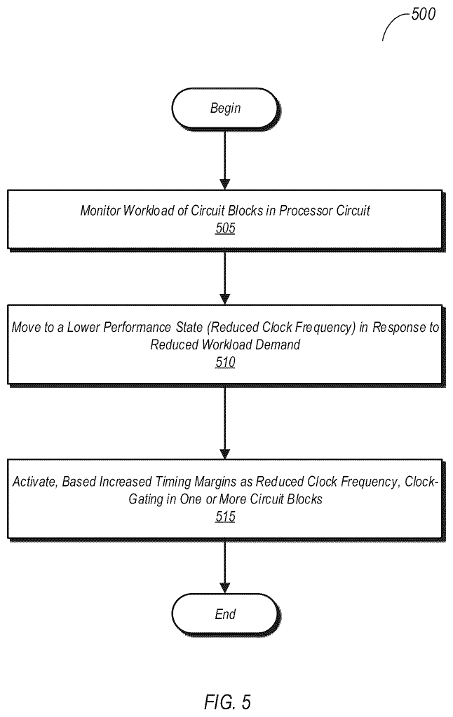

FIG. 5 is a flow diagram of another embodiment of a method for operating a processor circuit. As with Method 400 discussed above, Method 500 may be carried out using various embodiments of a processor circuit as discussed above. Furthermore, embodiments of a processor circuit capable of carrying out Method 500, but not otherwise discussed herein, is considered to fall within the scope of this disclosure.

Method 500 includes monitoring a workload of circuit blocks in a processor circuit (block 505). The monitoring of workloads for various circuit blocks may be carried out in different ways, and may be dependent on the function of the circuit block itself. For example, monitoring the workload of a general-purpose processing block may include monitoring the instruction throughput, and may further include distinguishing between workloads that are compute-intensive and memory intensive. Monitoring the workload of an I/O circuit may include determining the rate of input and/or output operations carried out thereby. These various metrics may be provided to activity monitoring circuits implemented in, e.g., a power management circuit.

The method further includes the power management circuit moving operation to a lower performance state in response to the activity monitoring circuits indicating a reduced workload demand (block 510). The lower performance state may include operation at a lower clock frequency, and may additionally include operation at a reduced operating (supply) voltage. In some embodiments of a processor circuit, this may include moving to a lower performance state for the entire processor. However, embodiments of a processor circuit are possible and contemplated herein in which the respective performance states of individual circuit blocks/units may be controlled independently with respect to one another.

Method 500 further includes activating, based on increased timing margins at the reduced clock frequency, clock-gating in one or more of the circuit blocks of the processing circuit (block 515). The clock-gating may be carried out using various ones of the techniques discussed above, depending on the particular configuration and function of the circuits. For example, a functional circuit block may include clock-gating circuitry implemented therein and, upon receiving a signal that operations are being carried out at a reduced clock frequency, perform clock-gating of the circuits therein when idle. Clock-gating may be carried out using the exclusive-OR clock-gating technique discussed above, eliminating clock toggles to one or more flip-flop circuits when their respective inputs and outputs remain unchanged.

Generally speaking, the clock-gating carried out at reduced clock frequencies as disclosed herein may allow for more fine-grained and temporary clock-gating than is possible at higher clock frequencies and/or without applying the various techniques discussed above. This in turn may result in additional savings of dynamic power over what is normally achieved from operation in the lower performance states.

### Device, System, and Computer-readable Medium Embodiments

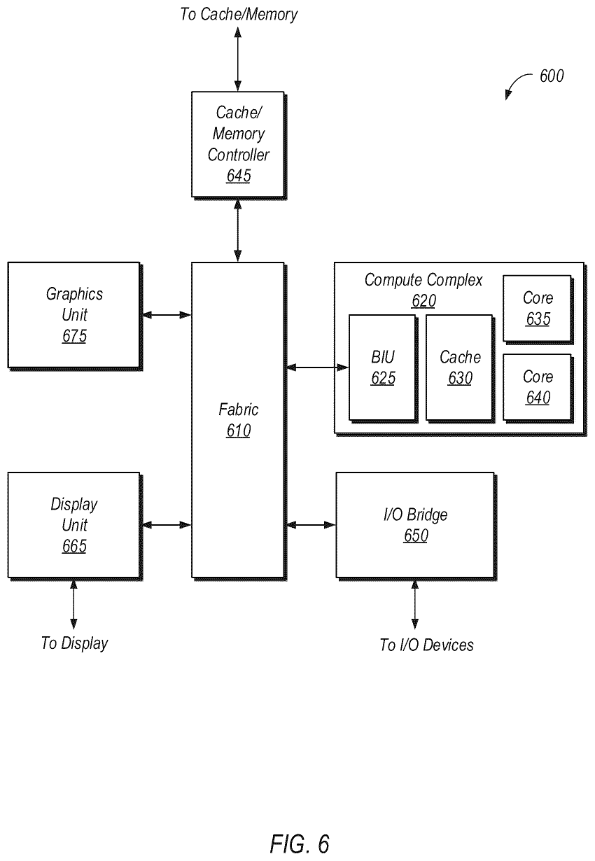

Referring now to FIG. 6, a block diagram illustrating an example embodiment of a device that may include performance state-aware clock-gating is shown. In some embodiments, elements of device 600 may be included within a system on a chip. In some embodiments, device 600 may be included in a mobile device, which may be battery-powered. Therefore, power consumption by device 600 may be an important design consideration. In the illustrated embodiment, device 600 includes fabric 610, compute complex 620, input/output (I/O) bridge 650, cache/memory controller 645, graphics unit 675, and display unit 665. In some embodiments, device 600 may include other components (not shown) in addition to, or in place of, the illustrated components, such as video processor encoders and decoders, image processing or recognition elements, computer vision elements, etc.

Fabric 610 may include various interconnects, buses, MUX's, controllers, etc., and may be configured to facilitate communication between various elements of device 600. In some embodiments, portions of fabric 610 may be configured to implement various different communication protocols. In other embodiments, fabric 610 may implement a single communication protocol, and elements coupled to fabric 610 may convert from the single communication protocol to other communication protocols internally.

In the illustrated embodiment, compute complex 620 includes bus interface unit (BIU) 625, cache 630, and cores 635 and 640. In various embodiments, compute complex 620 may include various numbers of processors, processor cores, and caches. For example, compute complex 620 may include 1, 2, or 4 processor cores, or any other suitable number. In one embodiment, cache 630 is a set associative L2 cache. In some embodiments, cores 635 and 640 may include internal instruction and data caches. In some embodiments, a coherency unit (not shown) in fabric 610, cache 630, or elsewhere in device 600, may be configured to maintain coherency between various caches of device 600. BIU 625 may be configured to manage communication between compute complex 620 and other elements of device 600. Processor cores, such as cores 635 and 640, may be configured to execute instructions of a particular instruction set architecture (ISA) which may include operating system instructions and user application instructions. These instructions may be stored in a computer readable medium such as a memory coupled to cache memory controller 645 as discussed below.

As used herein, the term “coupled to” may indicate one or more connections between elements, and a coupling may include intervening elements. For example, in FIG. 6, graphics unit 675 may be described as “coupled to” a memory through fabric 610 and cache/memory controller 645. In contrast, in the illustrated embodiment of FIG. 6, graphics unit 675 is “directly coupled” to fabric 610 because there are no intervening elements.

Cache/memory controller 645 may be configured to manage transfer of data between fabric 610 and one or more caches and memories. For example, cache/memory controller 645 may be coupled to an L3 cache, which may, in turn, be coupled to a system memory. In other embodiments, cache/memory controller 645 may be directly coupled to a memory. In some embodiments, cache/memory controller 645 may include one or more internal caches. Memory coupled to cache/memory controller 645 may be any type of volatile memory, such as dynamic random access memory (DRAM), synchronous DRAM (SDRAM), double data rate (DDR, DDR2,DDR3, etc.) SDRAM (including mobile versions of SDRAMs such as mDDR3, etc., and/or low power versions of SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to cache/memory controller 645 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 620 to cause the computing device to perform functionality described herein.

Graphics unit 675 may include one or more processors, e.g., one or more graphics processing units (GPUs). Graphics unit 675 may receive graphics-oriented instructions, such as OPENGL®, Metal®, or DIRECT3D® instructions, for example. Graphics unit 675 may execute specialized GPU instructions or perform other operations based on the received graphics-oriented instructions. Graphics unit 675 may generally be configured to process large blocks of data in parallel, and may build images in a frame buffer for output to a display, which may be included in the device or may be a separate device. Graphics unit 675 may include transform, lighting, triangle, and rendering engines in one or more graphics processing pipelines. Graphics unit 675 may output pixel information for display images. Graphics unit 675, in various embodiments, may include programmable shader circuitry which may include highly parallel execution cores configured to execute graphics programs, which may include pixel tasks, vertex tasks, and compute tasks (which may or may not be graphics-related).

Display unit 665 may be configured to read data from a frame buffer and provide a stream of pixel values for display. Display unit 665 may be configured as a display pipeline in some embodiments. Additionally, display unit 665 may be configured to blend multiple frames to produce an output frame. Further, display unit 665 may include one or more interfaces (e.g., MIPI® or embedded display port (eDP)) for coupling to a user display (e.g., a touchscreen or an external display).

I/O bridge 650 may include various elements configured to implement universal serial bus (USB) communications, security, audio, and low-power always-on functionality, for example. I/O bridge 650 may also include interfaces such as pulse-width modulation (PWM), general-purpose input/output (GPIO), serial peripheral interface (SPI), and inter-integrated circuit (I2C), for example. Various types of peripherals and devices may be coupled to device 600 via I/O bridge 650.

In some embodiments, device 600 includes network interface circuitry (not explicitly shown), which may be connected to fabric 610 or I/O bridge 650. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 600 with connectivity to various types of other devices and networks.

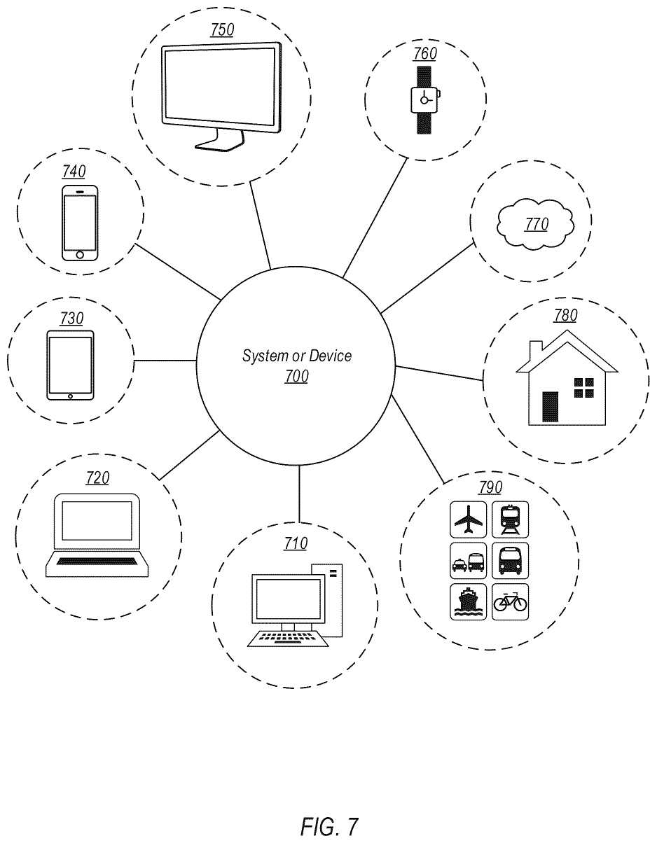

Turning now to FIG. 7, various types of systems that may include any of the circuits, devices, or systems discussed above are illustrated. System or device 700, which may incorporate or otherwise utilize one or more of the techniques described herein, may be utilized in a wide range of areas. For example, system or device 700 may be utilized as part of the hardware of systems such as a desktop computer 710, laptop computer 720, tablet computer 730, cellular or mobile phone 740, or television 750 (or set-top box coupled to a television).

Similarly, disclosed elements may be utilized in a wearable device 760, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 700 may also be used in various other contexts. For example, system or device 700 may be utilized in the context of a server computer system, such as a dedicated server or on shared hardware that implements a cloud-based service 770. Still further, system or device 700 may be implemented in a wide range of specialized everyday devices, including devices 780 commonly found in the home such as refrigerators, thermostats, security cameras, etc. The interconnection of such devices is often referred to as the “Internet of Things” (IoT). Elements may also be implemented in various modes of transportation. For example, system or device 700 could be employed in the control systems, guidance systems, entertainment systems, etc. of various types of vehicles 790.

The applications illustrated in FIG. 7 are merely exemplary and are not intended to limit the potential future applications of disclosed systems or devices. Other example applications include, without limitation: portable gaming devices, music players, data storage devices, unmanned aerial vehicles, etc.

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as design simulation, design synthesis, circuit fabrication, etc.

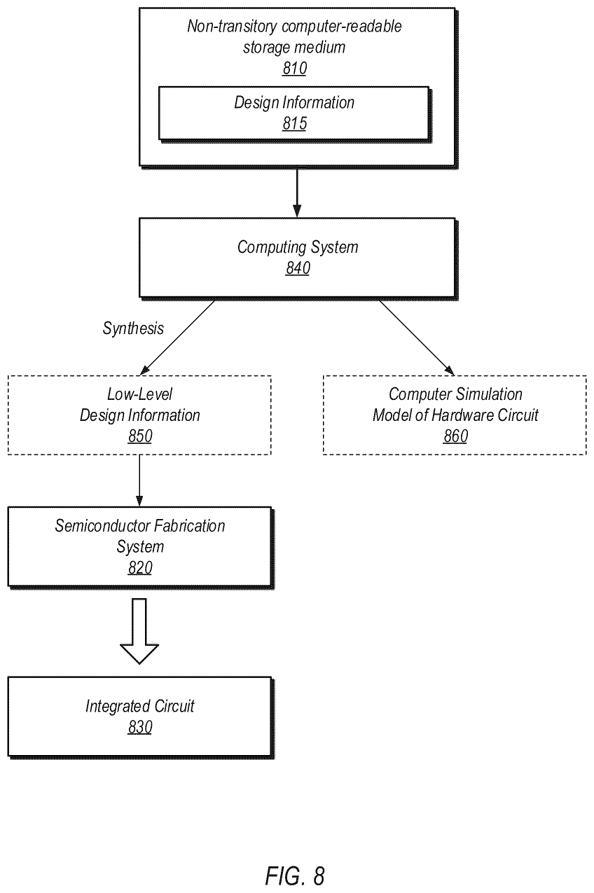

FIG. 8 is a block diagram illustrating an example of a non-transitory computer-readable storage medium that stores design information 815, according to some embodiments. In the illustrated embodiment, computing system 840 is configured to process design information 815. This may include executing instructions included in design information 815, interpreting instructions included in design information 815, compiling, transforming, or otherwise updating design information 815, etc. Therefore, design information 815 controls computing system 840 (e.g., by programming computing system 840) to perform various operations discussed below, in some embodiments.

In the illustrated example, computing system 840 processes design information 815 to generate both computer simulation model of hardware circuit 860 and low-level design information 850. In other embodiments, computing system 840 may generate only one of these outputs, may generate other outputs based on design information 815, or both. Regarding computer simulation model of hardware circuit 860, computing system 840 may execute instructions of a hardware description language that includes register transfer level (RTL) code, behavioral code, structural code, or some combination thereof. The simulation model may perform the functionality specified by design information 815, facilitate verification of the functional correctness of the hardware design, generate power consumption estimates, generate timing estimates, etc.

In the illustrated example, computing system 840 also processes design information 815 to generate low-level design information 850 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on low-level design information 850 (potentially among other inputs), semiconductor fabrication system 820 is configured to fabricate integrated circuit 830 (which may correspond to functionality of the computer simulation model of hardware circuit 860). Note that computing system 840 may generate different simulation models based on design information at various levels of description, including low-level design information 850, design information 815, and so on. The data representing low-level design information 850 and computer simulation model of hardware circuit 860 may be stored on non-transitory computer-readable storage medium 810, or on one or more other media.

In some embodiments, low-level design information 850 controls (e.g., programs) semiconductor fabrication system 820 to fabricate integrated circuit 830. Thus, when processed by the fabrication system, the design information may program the fabrication system to fabricate a circuit that includes various circuitry disclosed herein.

Non-transitory computer-readable storage medium 810 may comprise any of various appropriate types of memory devices or storage devices. Non-transitory computer-readable storage medium 810 may be an installation medium, e.g., a CD-ROM, floppy disks, or tape device; a computer system memory or random access memory such as DRAM, DDR RAM, SRAM, EDO RAM, Rambus RAM, etc. ; a non-volatile memory such as a Flash memory, magnetic media, e.g., a hard drive, or optical storage; registers, or other similar types of memory elements, etc. Non-transitory computer-readable storage medium 810 may include other types of non-transitory memory as well, or combinations thereof. Accordingly, non-transitory computer-readable storage medium 810 may include two or more memory media, which may reside in different locations for example, in different computer systems that are connected over a network.

Design information 815 may be specified using any of various appropriate computer languages, including hardware description languages such as, without limitation: VHDL, Verilog, SystemC, SystemVerilog, RHDL, M, MyHDL, etc. The format of various design information may be recognized by one or more applications executed by computing system 840, semiconductor fabrication system 820, or both. In some embodiments, design information 815 may also include one or more cell libraries that specify the synthesis, layout, or both of integrated circuit 830. In some embodiments, design information 815 is specified in whole, or in part, in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 830 may, in various embodiments, include one or more custom macrocells, such as memories, analog or mixed-signal circuits, and the like. In such cases, design information 815 may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 820 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 820 may also be configured to perform various testing of fabricated circuits for correct operation.

In various embodiments, integrated circuit 830 and computer simulation model of hardware circuit 860 are configured to operate according to a circuit design specified by design information 815, which may include performing any of the functionality described herein. For example, integrated circuit 830 may include any of various elements shown in FIGS. 1-7. Further, integrated circuit 830 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model does not imply that the instructions must be executed in order for the element to be met, but rather, specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by design information 815. The different circuit implementations may affect the performance, area, power consumption, etc. of a given design (potentially with tradeoffs between different design goals), but the logical function does not vary among the different circuit implementations of the same circuit design.

In some embodiments, the instructions included in design information 815 provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information included in low-level design information 850. Low-level design information 850 may program semiconductor fabrication system 820 to fabricate integrated circuit 830.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third,” when applied to a feature, do not imply any type of ordering (e.g., spatial, temporal, logical, etc.), unless stated otherwise.

The phrase “based on” is used to describe one or more factors that affect a determination.

This term does not foreclose the possibility that additional factors may affect the determination. That is, a determination may be solely based on specified factors, or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, a circuit, or a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), a functional unit, a memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as a structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits, or portions thereof, may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. An apparatus,
a processor circuit including a plurality of circuit blocks; and
a power management circuit configured to:
determine a workload demand for one or more of the plurality of circuit blocks; and
in response to a determination that the workload demand is less than a threshold level:
change a performance state of the processor circuit from a first performance state of a plurality of performance states to a second performance state of the plurality of performance states, wherein an amount of power consumed by the processor circuit operating in the second performance state is less than the amount of power consumed by the processor circuit operating in the first performance state; and
activate a first operational mode in at least one circuit block of the plurality of circuit blocks, wherein the first operational mode is based on a timing margin associated with the second performance state.

2. The apparatus of claim 1, wherein, to activate a first operational mode, the power management circuit is further configured to cause clock-gating of the at least one circuit block of the plurality of circuit blocks.

3. The apparatus of claim 2, further comprising one or more clock-gating circuits configured to perform the clock-gating of the at least one circuit block of the plurality of circuit blocks, wherein a given one of the one or more clock-gating circuit comprises one or more logic gates.

4. The apparatus of claim 2, wherein the power management circuit includes a storage element configured to store information indicative of which ones of plurality of circuit blocks is available for clock-gating when operating in the second performance state.

5. The apparatus of claim 2, wherein the power management circuit further includes one or more activity monitoring circuits configured to monitor respective activity levels for one or more of the plurality of circuit blocks, wherein the power management circuit is configured to activate the first operational mode based on an activity level detected by a particular one of the one or more activity monitoring circuits.

6. The apparatus of claim 2, wherein at least one of the plurality of circuit blocks includes at least exclusive-OR clock-gating circuit configured to, when the processor circuit is operating in the second performance state, determine if a respective states of an input and an output of a correspondingly coupled sequential circuit has changed, and, in response to a determination that the respective states of the input and the output of the correspondingly coupled sequential circuit has not change, perform clock-gating of the correspondingly coupled sequential circuit.

7. The apparatus of claim 2, wherein a given one of the plurality of circuit blocks includes a first flip-flop circuit comprising:
a first latch coupled to receive an input signal;
a second latch coupled to the first latch and configured to generate an output signal based on the input signal; and
a delay circuit coupled to receive a clock signal from a clock node;
wherein, when the processor circuit is operating in the first performance state, the first latch is coupled to receive the clock signal via the delay circuit; and
wherein, when the processor circuit is operating in the second performance state, the first latch is coupled to receive the clock signal directly from the clock node.

8. The apparatus of claim 1, wherein a given one of the plurality of performance states is defined by a combination of a supply voltage and a clock frequency, where the combination is unique with respect to other ones of the plurality of performance states.

9. The apparatus of claim 8, wherein the processor circuit is configured to operate at a first clock frequency when operating in the first performance state, and wherein the processor circuit is further configured to operate at a second clock frequency when operating in the second performance state, wherein the second clock frequency is less than the first clock frequency.

10. A method comprising:
determining, using a power management circuit, a workload demand for a processor circuit having a plurality of circuit blocks;
changing, in response to determining that the workload demand is less than a threshold level, a performance state of the processor circuit from a first one of a plurality of performance states to a second one of the plurality of performance states, wherein a power consumption of the processor circuit operating in the second one of the plurality of performance states is less than the power consumption of the processor circuit operating in the first one of the plurality of performance states; and
activating, using the power management circuit, a first operational mode in at least one circuit block of the plurality of circuit blocks, wherein the first operational mode is based on a timing margin associated with the second one of the plurality of performance states.

11. The method of claim 10, wherein activating the first operational mode comprises, based on the timing margin associated with the second one of the plurality of performance states, clock-gating of the at least one circuit block using one or more clock-gating circuits implemented within the at least one circuit block.

12. The method of claim 11, further comprising storing, in a storage element of the power management circuit, information indicative of which ones of the plurality of circuit blocks is available for clock-gating when operating in the second one of the plurality of performance states.

13. The method of claim 11, further comprising monitoring, using one or more activity monitoring circuits implemented in the power management circuit, respective activity levels for one or more of the plurality of circuit blocks.

14. The method of claim 13, further comprising activating, using the power management circuit, clock-gating based on an activity level detected by a particular one of the one or more activity monitoring circuits.

15. The method of claim 11, further comprising clock-gating a first sequential circuit in in the at least one circuit block by comparing, using an exclusive-OR gate, an input of the first sequential circuit to an output of the first sequential circuit.

16. The method of claim 15, further comprising clock-gating a plurality of sequential circuits, including the first sequential circuit by comparing, using corresponding ones of a plurality of exclusive-OR gates, respective inputs to respective outputs of ones of the plurality of sequential circuits and logically ORing respective outputs of the plurality of exclusive-OR gates to generate a clock-gating term.

17. The method of claim 10, wherein operating in the first one of the plurality of performance states comprises operating the processor circuit at a first clock frequency and operating the second one of the plurality of performance states comprises operating the processor circuit at a second clock frequency that is less than the first clock frequency.

18. A system comprising:
a processor circuit having a plurality of circuit blocks;
a power management circuit configured to determine a respective one of a plurality of performance states in which ones of the plurality of circuit blocks is to operate based on respectively determined workloads for ones of the plurality of circuit blocks, and wherein the power management circuit is further configured to, in response to determining that a workload demand for at least one circuit block of the plurality of circuit blocks is less than a threshold level:
change, for the at least one circuit block of the plurality of circuit blocks, operation from a first performance state having a first clock frequency to a second performance state having a second clock frequency less than the first clock frequency; and
activate, based on timing margins associated with the second clock frequency, a clock-gating mode in the at least one circuit block of the plurality of circuit blocks.

19. The system of claim 18, wherein the power management circuit includes a configured to store information indicative of which ones of the plurality of circuit blocks is available for clock-gating when operating in the second performance state.

20. The system of claim 18, wherein the at least one circuit block of the plurality of circuit blocks includes at least exclusive-OR clock-gating circuit configured to, when the processor circuit is operating in the second performance state, determine if a respective states of an input and an output of a correspondingly coupled sequential circuit has changed, and, in response to a determination that the respective states of the input and the output of the correspondingly coupled sequential circuit has not change, perform clock-gating of the correspondingly coupled sequential circuit.
